(19) United States
(12) Patent Application Publication
(10) Pub. No.: US 2026/0230555 A1
(43) Pub. Date: Aug. 6, 2026

(54) Call and Message Tracing Systems, Methods, and Applications

(71) Applicant: ECG, Inc., Valdosta, GA (US)

(72) Inventor: Mark Lindsey, Wake Forest, NC (US)

(73) Assignee: ECG, Inc., Valdosta, GA (US)

(21) Appl. No.: 19/452,560

(22) Filed: Jan. 19, 2026

Related U.S. Application Data
(60) Provisional application No. 63/752,120, filed on Jan. 31, 2025.

(51) Int. Cl. H04M 3/22; H04L 9/40

(52) U.S. Cl. CPC H04M 3/2281; H04L 63/0823

(57) ABSTRACT

The present invention relates to communication systems, methods, hardware, and software to trace communications through a network. The systems include an originating service provider configured to receive a communication transmitted from a communication originator, associate a communication identifier with the communication that includes at least a unique Event Certificate URL associated with a verification certificate for the communication, and transmit the communication with the associated identifier to subsequent service providers until the terminating service provider is reached that provides the communication to a communication recipient. Service providers along the communication path from the communication originator to recipient may be configured to receive the identified communication, extract the EventCertURL from the identified communication, request the verification certificate using the EventCertURL, receive the certificate, and verify the communication before further transmission. The system may be configured to log certificate requests, which may be used to trace calls through the network.

### CROSS-REFERENCE TO RELATED APPLICATIONS

This application claims priority to and the benefit of U.S. App No. 63/752,120 filed Jan. 31, 2025, the disclosure of which is incorporated herein by reference in its entireties.

### STATEMENT REGARDING FEDERALLY SPONSORED RESEARCH OR DEVELOPMENT

Not Applicable

### BACKGROUND OF THE INVENTION

### Field Of The Invention

The present invention generally relates to communication systems and methods. More specifically, the invention relates to systems, devices, and methods to trace communications, e.g., calls and messages, from an originating to a terminating service provider.

### Background

Robo-calls and messages and call quality and authentication remain a persistent challenge in modern communications. For example, while US law prohibits automated calls placed to mobile or cellular phones, no technology is available for reliably detecting automatically the nature of the technology used to reach a caller. (Breda v. Cellco Partnership, Case No. 1:16-cv-11512-DJC).

The STIR/SHAKEN (Secure Telephone Identity Revisited/Signature-based Handling of Asserted information using toKENs) framework and protocols were developed to combat illegal caller ID spoofing and robocalls and has had a positive impact in reducing fraudulent and unwanted calls.

However, despite the improvements provided by STIR/SHAKEN, there is a continuing need for communication systems and methods to reduce unwanted calls and messages and provide improved call quality and authentication.

### BRIEF SUMMARY OF THE INVENTION

The present invention addresses the above noted needs by providing a unique certificate URL as a public key certificate that is provided to the service providers along a network path from a caller/sender to a recipient. Then as verification activity occurs along the network path of the communication, requests for the unique certificate URL may be analyzed and correlated with the original communication and the information may be used to trace and analyze the communication on its path.

In various embodiments, such as those used with the STIR/SHAKEN protocol, the system may include an Original Certificate Resource (OrigCertResource) including at least one processor to
generate a unique Event Certificate URL (EventCertURL) associated with a verification certificate for a communication through the system,
send the verification certificate in response to a request including the EventCertURL, and
store the EventCertURL and information concerning requests including the EventCertURL;

A communication, such as a voice call or message, may be sent from communication originator, e.g., person or machine, to an originating service provider configured to
receive a communication transmitted from a communication originator;
request EventCertURL from the OrigCertResource;
attach a Personal Assertion Token (PASSporT) to the communication that includes at least a unique Event Certificate URL (EventCertURL), and
transmit the communication with attached PASSporT (PASSporT communication) to an intermediate service provider

The intermediate service provider may, in turn, be configured to
receive the PASSporT communication from one of the originating service provider and another intermediate service provider,
extract the EventCertURL from the PASSporT communication,
request the verification certificate from the OrigCertResource using the EventCertURL,
receive the verification certificate from the OrigCertResource,
verify that the communication as originating from the originating service provider, and
transmit the verified PASSporT communication to a subsequent intermediate service provider, which may be similarly configured, or a terminating service provider.

The terminating service provider may be configured, similar to intermediate service provider, to
receive the PASSporT communication from one of the originating service provider and another intermediate service provider,
extract the EventCertURL from the PASSporT communication,
request the verification certificate from the OrigCertResource using the EventCertURL,
receive the verification certificate from the OrigCertResource,
verify that the communication as originating from the originating service provider, and
transmit the communication to the communication recipient.

Various embodiments of systems and methods for tracing communications through a network may involve receiving, via at least one processor associated with an originating service provider, a communication transmitted from a communication originator, associating a communication identifier with the communication that includes at least a unique Event Certificate URL (EventCertURL) associated with a verification certificate for the communication and transmitting, via a transmitter associated with an originating service provider, the communication with the associated identifier (identified communication) to a subsequent service provider.

The subsequent service provider may be an intermediate or terminating service provider that receives, via a receiver, the identified communication, extracts the EventCertURL from the identified communication, and requests the verification certificate using the EventCertURL. When the verification certificate is received in response to the request, if the certificate and communication are verified, then the communication is transmitted to the next intermediate service provider or terminating service provider, if the subsequent is an intermediate service provider or the communication is transmitted to a communication recipient if the subsequent service provider is a terminating service provider.

Through the use of a unique EventCertURL associated with the verification certificate, service providers employing the present invention are able to log and trace communications through their networks, which was not possible using prior art methods.

Alternative embodiments provide a communication system where an originating service provider associates a communication identifier with the communication that includes at least a unique EventCertURL associated with a verification certificate, and transmits the communication with the associated identifier to subsequent service providers. The subsequent service providers receive the identified communication, extract the EventCertURL, request and receive the verification certificate, verify the communication, and transmit either the verified identified communication to a further subsequent service provider or the communication to a communication recipient when the subsequent service provider is a terminating service provider. The communications may be voice calls or messages and may be transmitted wirelessly through at least a portion of the system.

The invention further encompasses methods of tracing communications through a network by receiving a communication from a communication originator, associating a communication identifier including a unique EventCertURL with the communication, transmitting the identified communication, and having subsequent service providers extract the EventCertURL, request and receive the verification certificate, verify the communication, and transmit the communication along the network path to its final destination.

Other embodiments include communication tracing systems where the OrigCertResource generates unique EventCertURLs for each communication, associates them with verification certificates, stores them in an EventCertURL store, responds to certificate requests, and logs comprehensive request information including service provider identity, request time, network address, TLS client certificate information, and HTTP User-Agent data. This logged information enables tracing of communications through the network by correlating certificate requests with original communications and may be stored in a Certificate Access Data Store for analysis.

The EventCertURL may be constructed using various methods including a Standardized Fully Qualified Domain Name (StdFQDN) with a single domain name and customized path, a Dynamic Fully-Qualified Domain Name (DynFQDN) with modified domain names for each EventCertURL, or a Dynamic IP (DynIP) configuration that resolves to various IP addresses through DNS mechanisms to enable tracking while allowing caching of DNS responses and HTTPS connections.

STIR/SHAKEN specific implementations include an STI Authentication Service (STI-AS) associated with an Originating Service Provider that generates PASSporTs for each communication, requests unique EventCertURLs, includes them in PASSporTs, and transmits communications with PASSporTs. STI Verification Services (STI-VS) associated with Intermediate or Terminating Service Providers extract EventCertURLs from received PASSporTs, request verification certificates, and verify communications. The unique EventCertURLs prevent caching mechanisms from reusing old certificate versions, forcing each STI-VS to request certificates using the unique EventCertURL, while enabling analysis of request signatures for technology identification and correlation of call data with analytics from call-quality platforms, which may also be used to analyze communication paths and quality metrics, enabling identification of network performance issues and routing inefficiencies.

The invention includes methods for detecting automated calling technology by analyzing request signatures for indications of technology in use, identifying GSM Core identifiers, examining Client User Agents and TLS Client certificate generators, and determining whether communications originated from automated calling technology. Certificate delivery platforms record comprehensive data about requests, identify source systems by IP address and TLS Common Name, and correlate recorded data with original communications for network analysis and determination of intermediate service provider identities along communication paths.

The system prevents certificate caching by generating unique EventCertURLs for each communication and forcing verification services to request certificates using unique identifiers, thereby preventing reuse of cached certificates.

Hardware implementations include communication authentication apparatus with memory for storing verification certificates, processors for generating unique identifiers, network interfaces for receiving certificate requests and transmitting verification certificates, and logging modules for recording request details. Network path analysis methods deploy unique EventCertURLs with communications, monitor certificate requests, log service provider information, analyze logged information to determine routing paths, and generate network topology reports that identify previously unknown intermediate service providers.

Robocall detection and prevention systems include EventCertURL generation modules, request analysis modules for examining certificate requests for automated calling indicators, pattern recognition engines for identifying suspicious calling patterns based on request timing, frequency, and source characteristics, and alert systems for notifying service providers of potential robocall activity. Communication verification devices include input interfaces for receiving communications with PASSporTs, extraction modules for retrieving EventCertURLs, certificate request modules for obtaining verification certificates, verification engines for authenticating communications, and output interfaces for forwarding verified communications, with integration into intermediate service provider infrastructure for automatic operation.

Accordingly, the present disclosure addresses the continuing need for improved systems, devices, and methods to reduce unwanted calls and messages and provide improved call quality and authentication.

### BRIEF DESCRIPTION OF THE DRAWINGS

The accompanying drawings are included for the purpose of exemplary illustration of various aspects of the present invention, and not for purposes of limiting the invention, wherein:

FIG. 1 depicts exemplary embodiments of the system.

FIG. 2 illustrates exemplary components of devices and platforms for use in the present invention.

In the drawings and detailed description, the same or similar reference numbers may identify the same or similar elements. It will be appreciated that the implementations, features, etc. described with respect to embodiments in specific figures may be implemented with respect to other embodiments in other figures, unless expressly stated, or otherwise not possible.

### DETAILED DESCRIPTION OF THE INVENTION

Systems 100, devices, software, and methods of the present invention may be employed in various wired and/or wireless communication networks. For example, the present invention may be implemented in the call authentication platform STIR/SHAKEN, which is defined by the Alliance for Telecommunications Industry Solutions (ATIS) in standards ATIS-1000079, ATIS-1000080, ATIS-1000084 and associated standards, which are incorporated herein by reference. The standard defines a “Secure Telephony Identity” (STI) Authentication Service function, STI-AS, which operates (at minimum) at the Originating Service Provider (OSP). STIR/SHAKEN can be applied to other Session Initiation Protocol (SIP) operations, including the delivery of messages, and this invention relates communications generally including both to calls and messages.

In STIR/SHAKEN implementations of the present invention, the STI-AS software associated with the OSP generates a “Personal Assertion Token”, PASSporT, for each call that the OSP originates. The PASSporT contains the (1) calling party telephone number, the (2) called party telephone number, (3) date and time, and (4) an origination identifier, and (5) an attestation level indicating the type of information used to generate the PASSporT.

The STI-AS software creates a cryptographic signature of those five data items, signs it with a private key using a public-key cryptographic algorithm. For verification at Intermediate Service Providers (“IntSP”) and a Terminating Service Providers (“TSP”), a STI Verification Service, STI-VS, running on processors associated with those service providers must access the public key corresponding to the private key used by the STI-AS. For that reason, the STI-AS provides a URL along with the PASSporT so that the URL for the certificate is delivered along with the key.

In conventional call authentication deployments using STIR/SHAKEN, i.e. without the present invention, the certificate URL varies when the signing certificate is replaced or if it is provided to a new network.

In the present invention, for each new communication, e.g., call or message, a new unique certificate URL is generated and sent with the PASSporT in the SIP call signaling. This unique URL is referred to herein as an EventCertURL. The EventCertURL may be recorded in the certificate-delivery system associated with the STI-AS, and sent along with the PASSporT in the SIP message. Using the present invention does not render a network as non-compliant with the STIR/SHAKEN protocol, but improves the functionality of a STIR/SHAKEN implementation.

As a call flows to each IntSP or reaches the TSP, the STI-VS at each IntSP or the TSP will execute the verification process. In STIR/SHAKEN implementations of the present invention, the STI-VS receives the EventCertURL in the Identity header of the call/message and retrieves the certificate using the EventCertURL from a certificate delivery platform (OrigCertResource), which can record data about each request made via HTTPS or HTTP from each STI-VS, recording (1) the sequence of requests for the custom URL, (2) the source systems that make the requests (as identified by IP address and TLS Common Name provided in the client certificate), which represent the IntSP.

Because each EventCertURL is unique, caching mechanisms will not reuse an old version of the certificate. Therefore, STI-VS installations using caching, which may not, will still be forced to request the certificate using the unique EventCertURL.

The OSP may be configured to analyze the signature of each request from an STI-VS for indications of the technology in use, e.g., GSM Core identifiers of a mobile/cellular network including the Client User Agent, and the TLS Client certificate generator.

The call data may be correlated with the information about the original call using analytics, such as from call-quality platforms. The data recorded by the certificate delivery platform can be used to trace the call from the OSP, through all IntSPs, to the TSP.

The certificate requests can be associated with each communication and analyzed for reporting. The OSP can determine the identity of each IntSP's STI-VS along the path of a given call or message because each IntSP will request the same EventCertURL. Communication data may be analyzed to determine whether an IntSP is performing STI-VS, because the mandated verification function requires the STI-VS to access the certificate used.

The present invention may be implemented in various other embodiments. For example, the EventCertURL may be constructed with a single fully-qualified domain name, such as “certificate. ecg. co” and a customized path indicating the request, such as “5ae4ed63-50b9-400a-8ed7-bf8e6e1423b3” to construct an EventCertURL such as https://certificate.ecg.co/5ae4ed63-50b9-400a-8ed7-bf8e6e1423b3.crt, which may be referred to herein as Standardized Fully Qualified Domain Name (StdFQDN).

In this embodiment, the domain-name portion is not modified for each EventCertURL, which provides for caching of the Domain Name System (DNS) records, which may reduce delays in establishing connections in some scenarios and allow reuse of HTTPS connections.

In other embodiments, referred to herein as Dynamic Fully-Qualified Domain Name (DynFQDN) embodiments, the EventCertURL may be constructed with a fully-qualified domain name that is modified for each EventCertURL, such as “dc64980b-d7e8-4034-a435-a78d9c3ec0f7.certificate. ecg. co”, and either a consistent or dynamic URL path, producing an EventCertURL such as these:
https://dc64980b-d7e8-4034-a435-a78d9c3ec0f7.certificate. ecg. co/cert. crt
https://dc64980b-d7e8-4034-a435-a78d9c3ec0f7.certificate. ecg. co/59b05d6e-0d52-4a8c-9e38-168d 72b0dd38.crt.

DynFQDN embodiments allow the domain name portion to be changed, which permits the use of DNS as part of the OrigCertResource.

In other embodiments, referred to herein as DynIP, the EventCertURL uses either a static or dynamic FQDN and resolves it through DNS mechanisms to various IP addresses. For example, a request from IntSP 1 for dc64980b-d7e8-4034-a435-a78d9c3ec0f7.certificate. ecg. co may be configured to return the IP address 216.128.192.101 while a request from IntSP 2 for the same FQDN may be configured to return the IP address 216.128.192.102. DynIP embodiments allow for some of the advantages of caching connections and DNS responses relative to StdFQDN and DynFQDN.

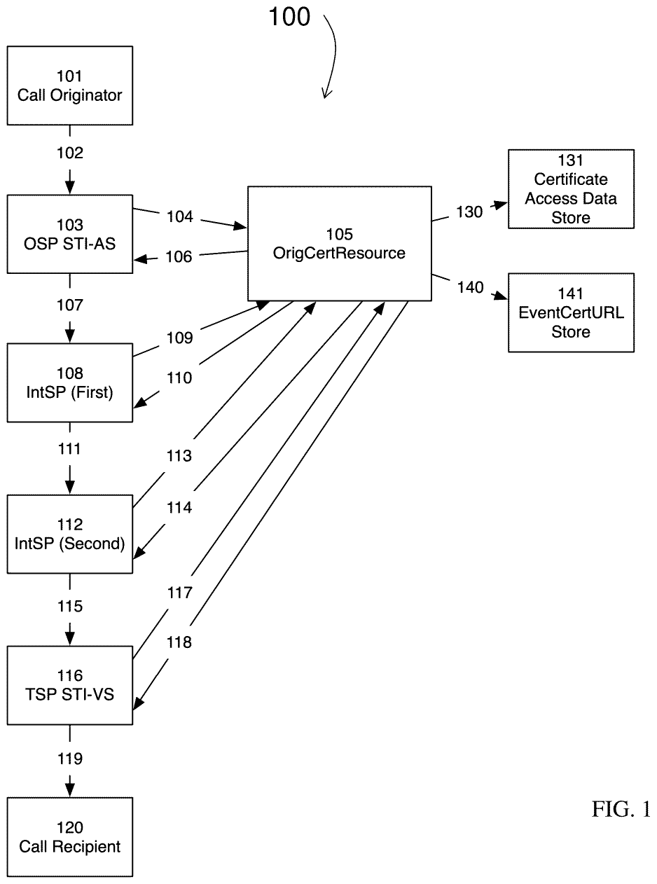

FIG. 1 depicts exemplary embodiments of system 100 operating in an exemplary transmission path for a call/message passing through a network. A communication, e.g., call, message, etc., originator (101) may an individual or organization placing an outbound communication through the network to a recipient. For ease of the description, the communication will be described as a call, but the communication may be a message or other communication. The call flows through network along a transmission path (102) to an Originating Service Provider (OSP) (103) running STI-AS software on one or more processors on one or more devices associated with the OSP and which may be local and/or remote. The STI-AS software requests (104) a PASSporT with a verification certificate from an OrigCertResource (105), which is a certificate delivery platform. The OrigCertResource (105) 1) generates a unique EventCertURL for the call, 2) stores via signal (140) the EventCertURL in the EventCertURL store (141), and returns (106) the PASSporT containing that EventCertURL to the STI-AS software running at the OSP 103.

The OSP (103) then routes the call (107) with the PASSporT toward the call recipient through a first Intermediate Service Provider, IntSP-1, (108), which is running STI-VS software. As part of the required call verification process, the STI-VS software extracts the EventCertURL contained in the PASSporT and requests (109) the verification certificate from the OrigCertResource 105.

The certificate request (109) is received by the OrigCertResource (105), which retrieves the the certificate associated with the EventCertURL extracted from the PASSporT from the EventCertURL store (141) replies to first Intermediate Service Provider 108 by returning the certificate contents (110).

In addition, the OrigCertResource (105) may also log the request from the Intermediate Service Providers. The logged request information may include (a) the first Service Provider sending the request including the network and IP address, (b) request time and date, (c) TLS client certificate provided, if any, and (d) the HTTP User-Agent. The request information may be sent (130) to a Certificate Access Data Store (131), where it is stored and may be accessed as desired. While the OrigCertResource (105), EventCertURL store (141), and Certificate Access Data Store (131) are shown as separate boxes to distinguish the functions, one of skill in the art will appreciate that these functions may be executed in software running on the same or different processors and devices that are commonly or remotely located.

After the certificate is retrieved (110) by the first Intermediate Service Provider (108) from the OrigCertResource (105), the STI-VS process proceeds and if the certificate is verifed, then the call is routed (111) to the next Intermediate Provider (112). The STI-VS software running at the next Intermediate Provider (112) performs the verification and logging processes as described above for the first Intermediate Provider (112), requesting a certificate (113) and receiving and verifying the returned certificate (114). Also as described above, the OrigCertResource (105) may also log the request information in the Certificate Access Data Store (131).

If the call is verified, the call proceeds through another network transmission path (118) to other Intermediate Service Providers as needed, eventually reaching the Terminating Service Provider (TSP) (116), which also requests the certificate (117), is logged (130) to the Certificate Access Data Store (131), and then receives the certificate (118). The call is then ultimately delivered to the Call Recipient (120) upon verification at the TSP.

One of skill in the art will appreciate that two intermediate service providers are shown only for explanation purposes and that none or any number of Intermediate service providers may be traversed along the path between the OSP and TSP 116.

When the request information from the various service providers is logged by the OrigCertResource (105), then the path of a call may be traced from the OSP to the TSP. The ability to trace a call and the verification process for the call from the OSP to the TSP was not possible in the prior art and now enables service providers to manage the calls passing through their networks more efficiently.

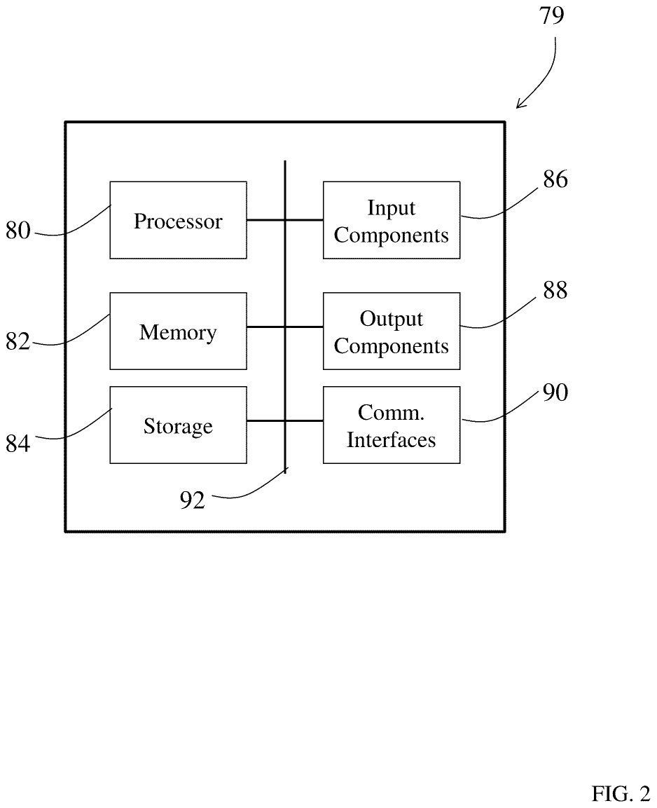

FIG. 2 illustrates exemplary component embodiments of various computing resources 79 that may be employed in the system 100 in a cloud-based and/or dedicated manner to run various applications. The computing resources may each include one or more processors 80, memory 82, storage 84, input components 86, output components 88, communication interfaces 90, as well as other components that may be interconnected as desired by the skilled artisan via one or more buses 92. As previously described, the components of the various computing resources may often be configured as a single device or multiple interdependent or stand-alone devices in close proximity and/or distributed over geographically remote areas.

Processor(s) 80 may include one or more general or Central Processing Units (“CPU”), Graphics Processing Units (“GPU”), Accelerated Processing Units (“APU”), microprocessors, and/or any processing components, such as a Field-Programmable Gate Arrays (“FPGA”), Application-Specific Integrated Circuits (“ASIC”), etc. that interpret and/or execute logical functions. The processors 80 may contain cache memory units for temporary local storage of instructions, data, or computer addresses and may be implemented as a single-chip, multiple chips and/or other electrical components including one or more integrated circuits and printed circuit boards that implement and execute logic in hardware, in addition to executing software.

Processor(s) 80 may connect to other computer systems and/or to telecommunications networks as part of performing one or more steps of one or more processes described or illustrated herein, according to particular needs. This can be accomplished through APIs or other methods, industry-specific formats, etc. Moreover, one or more steps of one or more processes described or illustrated herein may execute solely at the processor 80. In addition, or as an alternative, one or more steps of one or more processes described or illustrated herein for execution in one processor may be executed at multiple CPUs that are local or remote from each other across one or more networks.

The computing resources of the system 100 may implement processes employing hardware and/or software to provide functionality via hardwired logic or otherwise embodied in circuits, such as integrated circuits, which may operate in place of or together with software to execute one or more processes or one or more steps of one or more processes described or illustrated herein. Software implementing particular embodiments may be written in any suitable programming language (e.g., procedural, object oriented, etc.) or combination of programming languages, where appropriate.

Memory 82 may include Random Access Memory (“RAM”), Read Only Memory (“ROM”), and/or another type of dynamic or static storage device, such as flash, magnetic, and optical memory, etc. that stores information and/or instructions for use by processor 80. The memory 82 may include one or more memory cards that may be loaded on a temporary or permanent basis. Memory 82 and storage 84 may include a Subscriber Identification Module (“SIM”) card and reader.

Storage components 84 may store information, instructions, and/or software related to the operation of the system 100 and computing resources. Storage 84 may be used to store operating system, executables, data, applications, and the like, and may include fast access primary storage, as well as slower access secondary storage, which may be virtual or fixed. Storage 84 may include various types of memory 82.

Storage component(s) 84 may include one or more transitory and/or non-transitory computer-readable media that store or otherwise embody software implementing particular embodiments. The computer-readable medium may be any tangible medium capable of carrying, communicating, containing, holding, maintaining, propagating, retaining, storing, transmitting, transporting, or otherwise embodying software, where appropriate, including nano-scale medium. The computer-readable medium may be a biological, chemical, electronic, electromagnetic, infrared, magnetic, optical, quantum, or other suitable medium or a combination of two or more such media, where appropriate. Example computer-readable media include, but are not limited to fixed and removable drives, ASIC, Compact Disks (“CDs”), Digital Video Disks (“DVDs”, FPGAs, floppy disks, optical and magneto-optic disks, hard disks, holographic storage devices, magnetic tape, caches, Programmable Logic Devices (“PLDs”), RAM devices, ROM devices, semiconductor memory devices, solid state drives, cartridges, and other suitable computer-readable media.

Input components 86 and output components 88 may include various types of Input/Output (“I/O”) devices. The I/O devices often may include a Graphical User Interface (“GUI”) that provides an easy to use visual interface between the user and system 100 and access to the operating system or application(s) running on the devices.

Input components 86 receive any type of input in various forms from users or other machines, such as touch screen and video displays, keyboards, keypads, mice, buttons, track balls, switches, joy sticks, directional pads, microphones, cameras, transducers, card readers, voice and handwriting inputs, and sensors for sensing information such as biometrics, temperature & other environmental conditions, such as air quality, etc., location via Global Positioning System (“GPS”) or otherwise, accelerometer, gyroscope, compass, actuator data, which may be input and/or received via one or more communication interfaces 90.

Output component 88 may include visual displays, audio speakers, signaling devices, e.g., lights, other sensory devices, mechanical, or other electromagnetic digital or analog output. Similar to the input, the output may be provided via one or more ports and/or one or more communication interfaces 90.

Communication interface 90 may include one or more transceivers, receivers, transmitters, modulators, demodulators that enable communication with other devices, via wired and/or wireless connections. Communication interface 90 may include Ethernet, optical, coaxial, Universal Serial Bus (“USB”), Infrared (“IR”), Radio Frequency (“RF”) including the various Wi-Fi, WiMax, cellular, and Bluetooth protocols, such as Bluetooth, Bluetooth Low Energy (BLE), Wi-Fi (IEEE 802.11), Wi-Fi Direct, SuperWiFi, 802.15.4, WiMax, LTE systems, LTE Direct, past, current, and future cellular standard protocols, e.g., 4-5G, or other wireless signal protocols or technologies as described herein and known in the art.

Bus(es) 92 may connect a wide variety of other subsystems, in addition to those depicted, and may include various other components that permit communication among the components in the computing resources. The bus(es) 92 may encompass one or more digital signal lines serving a common function, where appropriate, and various structures including memory, peripheral, or local buses using a variety of bus architectures. As an example and not by way of limitation, such architectures include an Industry Standard Architecture (“ISA”) bus, an Enhanced ISA (“EISA”) bus, a Micro Channel Architecture (“MCA”) bus, a Video Electronics Standards Association Local Bus (“VLB”), a Peripheral Component Interconnect (“PCI”) bus, a PCI-eXtended (“PCI-X”) bus, a Peripheral Component Interconnect Express (PCIe) bus, a Controller Area Network (“CAN”) bus, and an Accelerated Graphics Port (“AGP”) bus.

The computing resources of the system 100 may provide functionality as a result of the processors 80 executing software embodied in one or more computer-readable storage media residing in the memory 82 and/or storage 84 and logic implemented and executed in hardware. The results of executing the software and logic may be stored in the memory 82 and/or storage 84, provided to output components 88, and transmitted to other devices via communication interfaces 90, which includes cloud storage and cloud computing. In execution, the processor 80 may use various inputs received from the input components 86 and/or the communications interfaces 90. The input may be provided directly to the processor 80 via the bus 92 and/or stored before being provided to the processor 80. Executing software may involve carrying out processes or steps may include defining data structures stored in memory 82 and modifying the data structures as directed by the software.

As used herein, the term component is intended to be broadly construed as hardware, firmware, and/or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

The foregoing disclosure provides examples, illustrations and descriptions of the present invention, but is not intended to be exhaustive or to limit the implementations to the precise form disclosed. Modifications and variations are possible in light of the above disclosure or may be acquired from practice of the implementations. These and other variations and modifications of the present invention are possible and contemplated, and it is intended that the foregoing specification and the following claims cover such modifications and variations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “at least one” or “one or more”. Furthermore, as used herein, the term “set” is intended to include one or more items and may be used interchangeably with “at least one” or “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A communication system comprising:
an Original Certificate Resource (OrigCertResource) including at least one processor to
generate a unique Event Certificate URL (EventCertURL) associated with a verification certificate for a communication through the system,
send the verification certificate in response to a request including the EventCertURL, and
store the EventCertURL and information concerning requests including the EventCertURL;
an originating service provider including at least one processor to
receive a communication transmitted from a communication originator;
request the EventCertURL from the OrigCertResource;
attach a Personal Assertion Token (PASSporT) to the communication that includes at least the EventCertURL, and
transmit the communication with attached PASSporT (PASSporT communication);
at least one intermediate service provider including at least one processor to
receive the PASSporT communication from one of the originating service provider and another intermediate service provider,
extract the EventCertURL from the PASSporT communication,
request the verification certificate from the OrigCertResource using the EventCertURL,
receive the verification certificate from the OrigCertResource,
verify that the communication as originating from the originating service provider, and
transmit the verified PASSporT communication to a subsequent intermediate service provider; and
a terminating service provider including at least one processor to
receive the PASSporT communication from one of the originating service provider and another intermediate service provider,
extract the EventCertURL from the PASSporT communication,
request the verification certificate from the OrigCertResource using the EventCertURL,
receive the verification certificate from the OrigCertResource,
verify that the communication as originating from the originating service provider, and
transmit the communication to a communication recipient.

2. A communication system comprising:
an originating service provider including at least one processor to
receive a communication transmitted from a communication originator;
associate a communication identifier with the communication that includes at least a unique Event Certificate URL (EventCertURL) associated with a verification certificate for the communication, and
transmit the communication with the associated communication identifier as an identified communication; and
at least one subsequent service provider including at least one processor to
receive the identified communication,
extract the EventCertURL from the identified communication,
request the verification certificate using the EventCertURL,
receive the verification certificate,
verify that the communication as a verified identified communication, and
transmit one of (i) the verified identified communication to a further subsequent service provider, and (ii) the communication to a communication recipient when the at least one subsequent service provider is a terminating service provider.

3. The system of claim 2, where the communication is one of a voice call and a message.

4. The system of claim 2, where the at least one subsequent service provider is a plurality of subsequent service providers and includes the terminating service provider.

5. The system of claim 2, where the communication is transmitted wirelessly through at least a portion of the system.

6. The system of claim 2, where the EventCertURL is provided to the originating service provider by an Original Certificate Resource (OrigCertResource) in response to a request to an Original OrigCertResource; and
the verification certificate is sent to the subsequent service provider by the OrigCertResource in response to the OrigCertResource receiving a request including the EventCertURL.

7. The system of claim 6, where the OrigCertResource generates the unique EventCertURL for the communication and stores the unique EventCertURL.

8. The system of claim 6, where the OrigCertResource logs and stores information about subsequent service providers requesting EventCertURL.

9. The system of claim 6, where the OrigCertResource logs request information including at least one of a service provider sending the request, request time and date, TLS client certificate provided, and HTTP User-Agent.

10. The system of claim 2, wherein the EventCertURL is constructed using one of:
a Standardized Fully Qualified Domain Name (StdFQDN) with a single domain name and a customized path,
a Dynamic Fully-Qualified Domain Name (DynFQDN) with a modified domain name for each EventCertURL, and
a Dynamic IP (DynIP) configuration that resolves to various IP addresses through DNS mechanisms.

11. A method of tracing a communication through a network comprising:
receiving, via at least one processor associated with an originating service provider, a communication transmitted from a communication originator;
associating a communication identifier with the communication that includes at least a unique Event Certificate URL (EventCertURL) associated with a verification certificate for the communication;
transmitting, via a transmitter associated with an originating service provider, the communication with the associated identifier (identified communication);
receiving, via at least one subsequent service provider including at least one processor, the identified communication;
extracting, via the at least one subsequent service provider, the EventCertURL from the identified communication;
requesting, via the at least one subsequent service provider, the verification certificate using the EventCertURL;
receiving, via the at least one subsequent service provider, the verification certificate,
verifying, via the at least one subsequent service provider, the communication, and
transmitting, via a transmitter associated with the at least one subsequent service provider, one of (i) the verified identified communication to a further subsequent service provider, and (ii) the communication to a communication recipient when the at least one subsequent service provider is a terminating service provider.

12. The method of claim 11, wherein the OrigCertResource generates the EventCertURL is generated by an Original Certificate Resource (OrigCertResource) by constructing a unique identifier using one of a Standardized Fully Qualified Domain Name (StdFQDN), a Dynamic Fully-Qualified Domain Name (DynFQDN), and a Dynamic IP (DynIP) configuration.

13. The method of claim 11, wherein the method is implemented within a STIR/SHAKEN framework using STI Authentication Service (STI-AS) and STI Verification Service (STI-VS) components.

14. The method of claim 11, further comprising storing the EventCertURL and associated verification certificate in an EventCertURL store and logging request information in a Certificate Access Data Store for subsequent analysis.

15. The method of claim 11, wherein the EventCertURL is generated by an Original Certificate Resource (OrigCertResource) and provided to the originating service provider in response to a request from the originating service provider.

16. The method of claim 15, wherein the OrigCertResource logs request information including service provider identity, request time, and network address for each request for the verification certificate.

17. The method of claim 11, wherein the communication identifier comprises a Personal Assertion Token (PASSporT) that includes the EventCertURL.

18. The method of claim 17, wherein the method is implemented using STIR/SHAKEN protocols.

19. The method of claim 11, wherein the EventCertURL is unique for each communication to prevent caching of verification certificates.

20. The method of claim 11, further comprising analyzing signatures of certificate requests to identify technology characteristics of service providers along the communication path.
